(19) United States
(12) Patent Application Publication
(10) Pub. No.: US 2006/0184911 A1
(43) Pub. Date: Aug. 17, 2006

(54) Labeling method and software utilizing the same, and PCB and electronic device utilizing the same

(75) Inventors: Shu-Chih Chen, Taipei County (TW); Chun-Chi Hsu, Taipei (TW); Ching-Yuan Wu, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/352,995

(22) Filed: Feb. 14, 2006

(30) Foreign Application Priority Data
Feb. 14, 2005 (TW) 94104175

(51) Int. Cl. G06F 17/50

(52) U.S. Cl. 716/15

(57) ABSTRACT

A labeling method for a printed circuit board comprising a first layout face and a second layout face opposite to the first layout face. The labeling method comprises defining a track region in the first layout face, defining a first mapping region mapped by the track region on the second layout face; and defining a first corresponding region on the second layout face completely enclosing the first mapping region.

### BACKGROUND

The disclosure relates to a labeling method, and more particularly to a labeling method for protecting critical signals.

Printed circuit boards (PCB) of electronic products comprise many tracks. A portion of tracks transmit important signals, such as video signals, audio signals, or clock signals. These important signals are easily interfered with by noise or power. The electronic product may fail when the important signals on a PCB are interfered with by noise. Thus, the electronic product must pass electromagnetic interference (EMI) or electromagnetic compatibility (EMC). Some reasons electronic product fail EMI or EMC tests is their PCB labeling method.

Generally, a PCB may comprise a plurality of layout faces with tracks formed thereon. The tracks transmitting signals and power are typically disposed on different layout faces. FIG. 1a is a cross-section of a conventional PCB. PCB 10 comprises layout faces 11 and 12 and isolation layer 13 disposed between the layout faces 11 and 12. FIG. 1b is a conventional labeling method. Tracks 110 are disposed on layout face 11. Tracks 120 indicated by the dotted lines are disposed on layout face 12 opposite to layout face 11.

An isolation layer (not shown) is disposed between layout faces 11 and 12. As tracks 110 and 120 have different voltage levels, respectively, a parasitical capacitor is generated between tracks 110 and 120, interfering with signal transmission.

Conventional layout software provides no function for protecting important signals. For example, layout face 11 comprises tracks transmitting important signals, such as tracks 110, as tracks 120 of layout face 12, pass through a mapping region mapped by tracks 110, important signals in tracks 110 will be interfered with by other signals on tracks 120 causing impedances of tracks 110 to be non-continuous, thus, reducing PCB quality.

### SUMMARY

The invention provides a labeling method for a printed circuit board (PCB). The PCB comprises a first layout face and a second layout face opposite to the first layout face. The labeling method comprises defining a track region in the first layout face, defining a first mapping region mapped by the track region on the second layout face, and defining a first corresponding region in the second layout face completely enclosing the first mapping region.

In addition, a computer program is provided for executing the above labeling method.

In addition, a PCB is provided, comprising a first layout face, a second layout face, and a first isolation layer. The first layout face comprises a track region. The second layout face is opposite to the first layout face and comprises a first corresponding region and a first metal layer. The first metal layer completely encloses the first corresponding region completely enclosing a first mapping region mapped by the track region on the second layout face. The first isolation layer is disposed between the first and second layout faces.

An electronic device comprising the above PCB is also provided.

### BRIEF DESCRIPTION OF THE DRAWINGS

The invention can be more fully understood by reading the subsequent detailed description and examples with reference made to the accompanying drawings, wherein:

FIG. 1a is a cross-section of a conventional PCB;

FIG. 1b is a conventional labeling method;

FIG. 2 is a PCB utilizing a labeling method according to an embodiment of the invention;

FIG. 3 is a PCB utilizing a labeling method according to an embodiment of the invention;

FIG. 4 is a PCB utilizing a labeling method according to an embodiment of the invention;

FIG. 5 is a flowchart of the labeling method according to an embodiment of the invention.

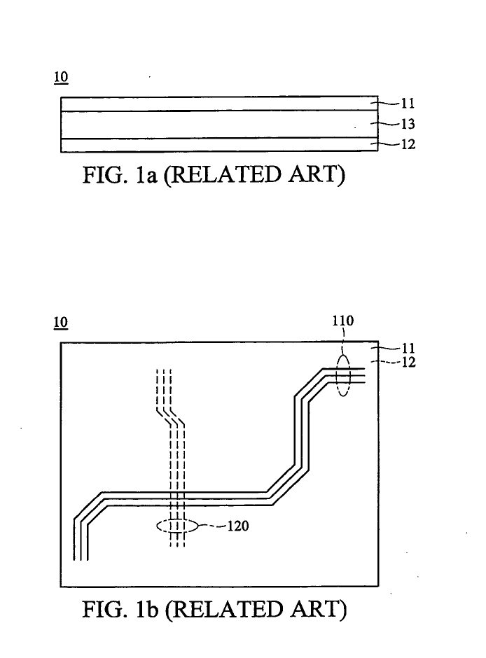

### DETAILED DESCRIPTION

Since important tracks are easily interfered with by noise, the invention defines corresponding regions on upper and/or lower layout faces. The corresponding regions completely enclose important tracks. Tracks on different layout faces must not pass through the corresponding regions to avoid important signals on tracks from being interfered with by the tracks on other layout faces.

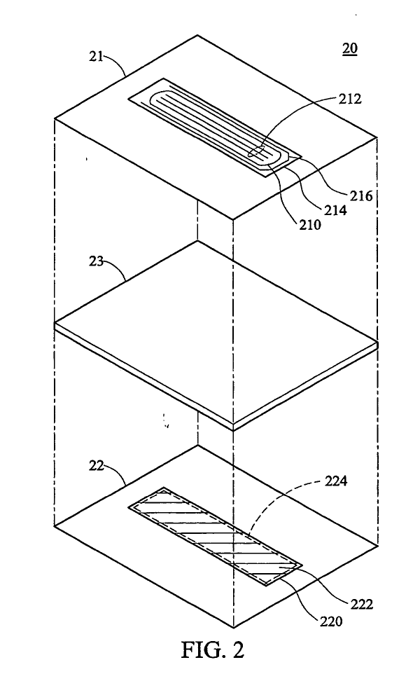

FIG. 2 is a PCB utilizing a labeling method according to an embodiment of the invention. PCB 20 comprises layout faces 21 and 22, and an isolation layer 23 disposed between layout faces 21 and 22. Layout face 22 is opposite to the layout face 21.

This embodiment of the labeling method defines track region 210 on layout face 21 for disposing tracks transmitting important signals, such as tracks 212. A mapping region 224 mapped by track region 210 is defined on layout face 22. Corresponding region 220 on layout face 22 is defined enclosing mapping region 224.

The area of corresponding region 220 equals or exceeds mapping region 224. Other tracks must not cross corresponding region 220, thus, signals in tracks 212 are not interfered with by noise.

Metal layer 222 is disposed on and completely covers corresponding region 220. For example, metal layer 222 covers corresponding region 220 according to a face method or a meshed method. Track region 214 is defined in layout face 21 and encloses track region 210 for disposing tracks 216. Tracks 216 can partially or completely enclose tracks 212. In this embodiment, track 216 partially encloses tracks 212.

To increase protection of signals in tracks 212, the voltage levels of metal layer 222 and track 216 can be fixed. The voltage level of metal layer 222 and that of track 216 are the same. In this embodiment, the voltage levels of metal layer 222 and track 216 are all at ground level.

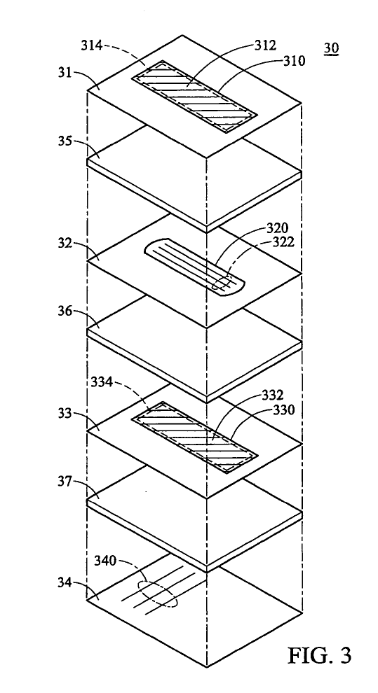

FIG. 3 is a PCB utilizing a labeling method according to another embodiment of the invention. PCB 30 comprises layout faces 31˜34 and isolation layer 35˜37. Layout face 32 has track region 320 for disposing tracks transmitting important signals having lower noise tolerance, such as tracks 332. Tracks 340 near tracks 322 or mapping tracks 322 are disposed on layout face 34.

Layout face 31 above layout face 32 defines corresponding region 310. The area of corresponding region 310 can equal or exceed track region 320 for completely enclosing mapping region 314 mapped by track region 320. Layout face 31 further comprises metal layer 312 covering corresponding region 310 according to a face method for interference with important signal on tracks 322.

Layout face 33, below layout face 32, defines corresponding region 330. The area of corresponding region 330 can equal or exceed track region 320 to completely enclose mapping region 334 mapped by track region 320. Layout face 33 further comprises metal layer 332 covering the corresponding region 330 according to a face method.

The areas of metal layers 312 and 332 are equal or unequal. The voltage levels of metal layers 312 and 332 are equal such that the magnetic field between metal layers 312 and 332 is fixed for avoiding external interference. When the voltage levels of metal layers 312 and 332 are at ground level, electromagnetic distribution between metal layers 312 and 332 will be reduced.

To increase efficiency, track region 320 is defined on layout face 32 and encloses tracks 322. Metal layers 312 and 332 and tracks 322 have the same voltage level for completely enclosing tracks 322.

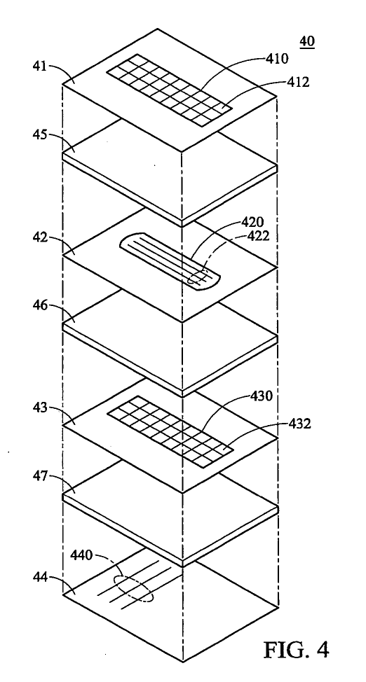

FIG. 4 is a PCB utilizing a labeling method according to another embodiment of the invention. Layout faces 41 and 43 respectively comprise corresponding regions 410 and 430. Metal layers 412 and 432 respectively cover corresponding regions 410 and 430 according to a meshed method. The covering method of metal layer 412 and that of metal layer 432 are equal or unequal. In this embodiment, metal layers 412 and 432 utilize the meshed method. Additionally, metal layer 412 can utilize a face method to cover track region 420 and metal layer 432 can utilize the meshed method to cover track region 420.

As shown in FIG. 4, metal layers 412 and 432 are formed by a plurality of metal tracks connected by an interlacing method. A plurality of blocks are formed by metal tracks. The width of the metal tracks is approximately between 1 mil to 10 mil. The length of the blocks is approximately between 1 mil to 10 mil.

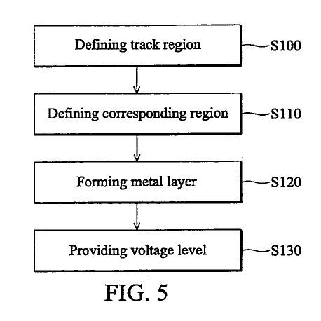

FIG. 5 is a flowchart of the labeling method according to an embodiment of the invention. The labeling method can be used in a PCB having at least two layout faces. Specifically, a PCB having two layout faces is given as an example. As shown in FIG. 2, the labeling method is utilized in a PCB 20 comprising layout faces 21 and 22. Layout face 22 is opposite to layout face 21.

First, in step 100, track region 210 is defined on layout face 21. Corresponding region 220 is defined on layout face 22 and completely enclosing mapping region 224 in step 110. The mapping region 224 on layout face 22 is a region mapped by track region 210. In step 120, metal layer 222 is formed on corresponding region 220. Metal layer 222 completely covers corresponding region 220 according to face or meshed methods. In step 130, metal layer 222 receives a voltage level, such as ground level, for avoiding noise interference.

The invention protects important tracks in track regions. A PCB having four layout faces is given as an example. As shown in FIG. 4, corresponding regions 310 and 330 are respectively defined on layout faces 31 and 33. Metal layers 312 and 332 are respectively disposed on corresponding regions 310 and 330 and receives a voltage level for protecting important track on track region 320.

The labeling method according to some embodiments of the invention can be applied to layout software for increasing protective capability thereof. An electronic device utilizing the labeling method can restrain electromagnetic distribution.

While the invention has been described by way of example and in terms of preferred embodiment, it is to be understood that the invention is not limited thereto. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A labeling method for a printed circuit board comprising a first layout face and a second layout face opposite to the first layout face, the labeling method comprising:
defining a track region on the first layout face; and
defining a first corresponding region on the second layout face completely enclosing a first mapping region on the second layout face, the mapping region mapped by the track region.

2. The labeling method as claimed in claim 1, further comprising:
defining a second corresponding region on the third layout face completely enclosing the second mapping region on the second layout face, the second mapping region mapped by the track region, and the first layout face is disposed between the second and third layout faces.

3. The labeling method as claimed in claim 2, further comprising supplying a voltage level to the first and the second corresponding regions.

4. The labeling method as claimed in claim 3, wherein the voltage level is a ground level.

5. The labeling method as claimed in claim 2, further comprising:
forming a first metal layer on the first corresponding region; and
forming a second metal layer on the second corresponding region.

6. The labeling method as claimed in claim 5, wherein the first and the second metal layers respectively cover the first and the second corresponding regions.

7. The labeling method as claimed in claim 6, further comprising:
forming a plurality of metal tracks respectively on the first and the second metal layers, wherein the metal tracks are connected by an interlacing method for forming a plurality of blocks, the width of the metal tracks is approximately between 1 mil to 10 mil, and the length of the blocks is approximately between 1 mil to 10 mil.

8. A computer program executing the labeling method as claimed in claim 1.

9. A printed circuit board, comprising:
a first layout face comprising a track region;
a second layout face opposite to the first layout face comprising a first corresponding region and a first metal layer completely enclosing the first corresponding region completely enclosing a first mapping region mapped by the track region on the second layout face; and
a first isolation layer disposed between the first and second layout faces.

10. The printed circuit board as claimed in claim 9, further comprising:
a third layout face comprising a second corresponding region and a second metal layer completely enclosing the second corresponding region completely enclosing a second mapping region mapped by the track region on the third layout face; and
a second isolation layer disposed between the first layout face and the third layout face.

11. The printed circuit board as claimed in claim 10, wherein the first and second metal layers are coupled to a voltage level.

12. The printed circuit board as claimed in claim 11, wherein the voltage level is a ground level.

13. The printed circuit board as claimed in claim 10, wherein the first and the second metal layers have a meshed structure.

14. The printed circuit board as claimed in claim 10, wherein the first and the second metal layers have a face structure.

15. The printed circuit board as claimed in claim 10, wherein the first metal layer or the second metal layer has a meshed structure.

16. The printed circuit board as claimed in claim 13, wherein the first and the second metal layers respectively comprise a plurality of metal tracks connected by an interlacing method for forming a plurality of blocks, the width of the metal tracks is approximately between 1 mil to 10 mil, and the length of the blocks is approximately between 1 mil to 10 mil.

17. An electronic device comprising the printed circuit board as claimed in claim 9.
